(19) United States
(12) Patent Application Publication
(10) Pub. No.: US 2012/0063258 A1
(43) Pub. Date: Mar. 15, 2012

(54) DETACHABLE BUCKET MIXER

(75) Inventors: David S. Iverson, Chicago, IL (US); Leopold Budzik, Glenview, IL (US)

(73) Assignee: TRIM-TEX, INC., Lincolnwood, IL (US)

(21) Appl. No.: 12/881,543

(22) Filed: Sep. 14, 2010

(51) Int. Cl. B28C 5/18

(52) U.S. Cl. 366/63

(57) ABSTRACT

A detachable bucket mixer for mixing viscous fluids and compositions while holding the bucket stationary during the mixing process includes a rotational drive and a clamping frame for mounting the rotational drive to a container. The clamping frame includes a barrel having a central axis, and two or more arms extending radially from the barrel. At the distal end of each of the arms is a flange having a claw-shaped grip configured to affix to a rim of the container. The arms may be capable of telescoping in order to accommodate varying diameters of buckets. Extending downward from the barrel is a drive shaft that may include a detachable mixing paddle configured for mixing viscous fluids. When the rotational drive is inserted into the barrel, it is connected to the detachable mixing paddle through the drive shaft to commence mixing. The clamping frame is configured to prevent rotation of the bucket relative to the rotational drive.

### BACKGROUND OF THE INVENTION

The present invention is directed to a mixer. More particularly, the present invention pertains to a mixer for attaching to associated buckets.

Mixing drywall compound, also known as mud, is a familiar task for builders and construction workers. The mixture is often prepared on-site and may be mixed manually and/or by using a variety of different mixing tools.

Often the device used to mix the compositions is simply an elongated rod with a blade attached at an end. The user then stirs or manually rotates the blade in order to stir the contents of the bucket. This process can be exhausting, especially for particularly viscous fluids. In addition, the mixture may not be combined fully and the process can be very time consuming. Furthermore, the blade may gouge the sides of the container if the user is not careful with placement of the blade.

Hand-held electric drills with paddles or blade attachments have also been used. However, these too are known to cause the bucket to be gouged if not held properly and are known to cause splatter of the contents of the bucket if the drill is removed prematurely. In addition, these drills can cause the bucket to vibrate and spin with the rotation of the drill, especially if the composition becomes too viscous for the drill to manage and the bucket is not properly secured.

Accordingly, there is a need for an improved device to mix mud. Desirably, such a device is easy to use and mixes mud quickly and efficiently. More desirably, such a device reduces splatter, vibration, and spin of the bucket. Such a device could, desirably, be used with a variety of different sizes and shapes of buckets and containers.

### BRIEF SUMMARY OF THE INVENTION

A detachable bucket mixer for mixing viscous fluids and compositions while holding the bucket stationary during the mixing process includes a rotational drive and a clamping frame for mounting the rotational drive to a container or bucket.

The clamping frame includes a coupler or barrel having a central axis, and two or more arms extending radially from the barrel. At the distal end of each of the arms is a flange having a claw-shaped grip configured to affix to a rim of the container. The arms may be capable of telescoping in order to accommodate varying diameters of buckets

Integral with and extending upward from at least two of the arms are vertical support columns. The top of each vertical support column is formed into a support-type cradle, and configured to allow, for example, a horizontal member (i.e. handle) of the associated rotational drive, to rest or lay in a recess in the cradle.

Extending downward from the barrel is a drive shaft. The drive shaft may include a detachable mixing paddle configured for mixing viscous fluids. The barrel and the drive shaft have complementary shapes, such as hexagonal or other interfering fit, such that the drive shaft may move or float freely in the vertical direction when coupled to the barrel to accommodate varying depth of buckets, but so that the shafts cannot freely rotate relative to one another. A drive end of the barrel has an opening into which the end of a rotational drive, such as a drill, may be inserted, opposite the drive shaft. When the rotational drive is inserted, it is connected to the detachable mixing paddle through the drive shaft. It is contemplated that many different types of rotational drives may be positioned in the opening of the barrel of the device, including manual and non-manual devices.

In an alternate embodiment, the detachable bucket mixer includes a clamping frame for mounting the rotational drive to the bucket. The clamping frame includes a drive mount having a central axis and at least three arms extending radially from the drive mount. An end of each arm has a securing member to affix the clamping frame to the bucket. The drive mount is configured to secure the rotational drive and the clamping frame is configured to prevent rotation of the bucket relative to the rotational drive.

The drive mount can be is configured as a collar and can include a clamp for securing the rotational drive in the collar. The arms can be adjustable to secure the mixer to buckets of different diameters. The arms can include mechanical fasteners to secure the arms to the bucket.

These and other features and advantages of the present invention will be apparent from the following detailed description, in conjunction with the appended claims.

### BRIEF DESCRIPTION OF THE SEVERAL VIEWS OF THE DRAWINGS

The benefits and advantages of the present invention will become more readily apparent to those of ordinary skill in the relevant art after reviewing the following detailed description and accompanying drawings, wherein:

FIG. 1 is a perspective view of the detachable bucket mixer in accordance with the principles of the present invention;

FIG. 2 is another embodiment of the detachable mud mixer;

FIG. 3 illustrates another embodiment of the detachable mud mixer, shown without the rotational drive or the bucket; and

FIG. 4 illustrates the mixer of FIG. 3 with a drive and mounted to a bucket.

### DETAILED DESCRIPTION OF THE INVENTION

While the present invention is susceptible of embodiment in various forms, there is shown in the drawings and will hereinafter be described a presently preferred embodiment with the understanding that the present disclosure is to be considered an exemplification of the invention and is not intended to limit the invention to the specific embodiment illustrated.

It should be further understood that the title of this section of this specification, namely, “Detailed Description Of The Invention”, relates to a requirement of the United States Patent Office, and does not imply, nor should be inferred to limit the subject matter disclosed herein.

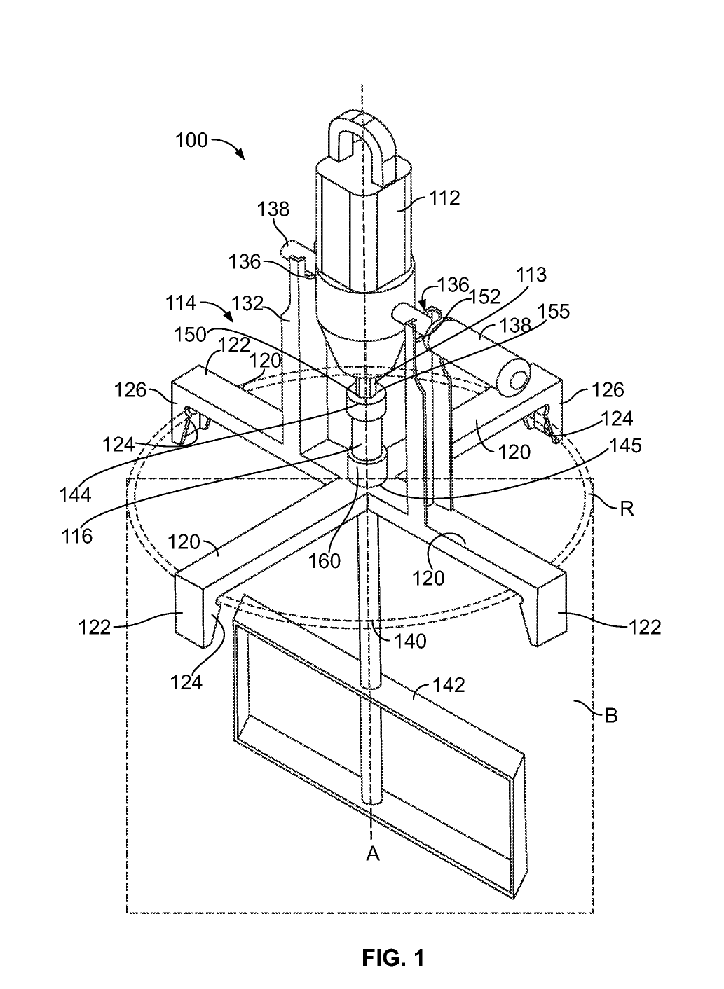

Referring now to FIG. 1, a detachable bucket mixer 100 for attachment to a bucket or container B includes a rotational drive 112 and a clamping frame 114. The rotational drive 112, such as a rotary drill, is releasably attached or connected to the clamping frame 114 which in turn is snapped onto the opening of a standard five (5) gallon bucket, a drywall compound (mud) bucket, a one (1) gallon paint can, or the like.

The clamping frame 114 includes a coupler or barrel 116 having a central axis A and two or more rigid arms 120 extending radially from the barrel 116. The barrel 116 has a first receiving end 145 and a second receiving end 155. The second receiving end 155 has a shape complementary to and configured to receive a drive shaft 140 while the first receiving end 145 is configured to receive a rotational drive 112.

The arms 120 may be symmetrically or asymmetrically positioned radially about the circumference of the barrel 116. While in the present example four arms 120 are shown in FIG. 1, it is anticipated that two or more arms may be present in accordance with the scope and spirit of the present invention. At the distal end 122 of each of the arms 120 is a flange 124 having a claw-shaped grip 126 configured to snap or affix to a rim of the bucket B.

Integral with and extending upward from at least two of the four arms 120 are vertical support columns 132. As illustrated, the columns 132 can be channel shaped. The top 152 of each vertical support column 132 is formed into a support-type cradle 136, and is configured to allow, for example, a horizontal member 138 (i.e. handle) of an associated rotational drive 112, to rest or lay in a recess 152 in the cradle 136.

Extending downward from the barrel 116 is a drive shaft 140. The drive shaft 140 is formed in a shape complementary to the receiving end 155 of the barrel 116, such as a hexagon or round shape, and is configured to float in a linear direction within the receiving end 155, either freely or in segmented lengths. The drive shaft 140 also includes a mixing blade or paddle 142 configured for mixing viscous fluids. The mixing paddle 142 may be formed integrally with the drive shaft 140 or may be detachable from the drive shaft 140. The barrel 116 can be affixed (as by a fastener, not shown) to either the drive shaft 140 or the rotational drive shaft 113, and an opposite end of the barrel (either end 145 or 155) can be allowed to float. It is contemplated that the “floating” end of the barrel (145 or 155) will have a shape (such as a hexagonal shape) that is complementary to that of the shaft 140, 113 received therein. In this manner, the shaft 140 and paddle 142 will be allowed to float in the mud. It will be appreciated in such an arrangement, the complementary shapes (e.g., hexagonal fittings) provide an interfering fit, such that the drive shafts 113 or 140 may move or float freely in the vertical direction when coupled to the barrel 116, to accommodate varying depth of buckets, but will prevent the shafts 113, 140 from freely rotating relative to one another.

Opposite the drive shaft is a drive end 144 of the barrel 116 with an opening 150 into which the rotational drive 112, such as a drill, may be inserted. When the rotational drive 112 is inserted, it is connected to the detachable mixing paddle 142 through the drive shaft 140. It is contemplated that many different types of rotational drives 112 may be positioned in the opening 150 of the barrel 116 of the mud mixer 100 and that the rotational drive 112 may be motorized or manual. One or more bearings 160 may be included to facilitate smooth rotation of the shaft 140.

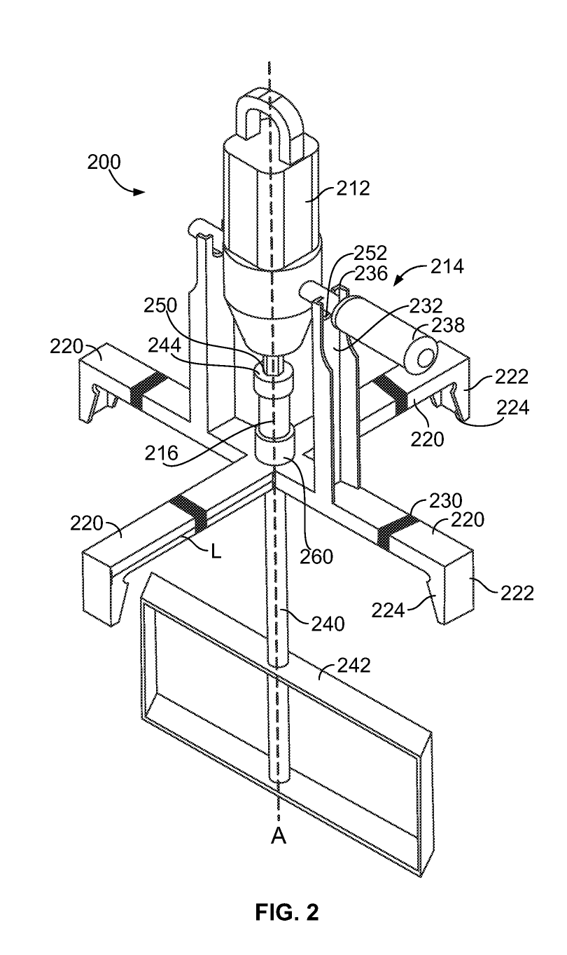

Turning now to FIG. 2, another embodiment of the mud mixer 200 is shown having a rotational drive 212 and a clamping frame 214. The clamping frame 214 includes a coupler or barrel 216 having a central axis A₁, a first and a second receiving end, and four arms 220 extending radially from the barrel 216. At the distal end 222 of each of the four arms 220 is a flange 224 having a claw-shaped grip 226 configured to snap or affix to a rim of the associated bucket B.

The arms 220 are able to telescope (see generally at 230) to change or modify arm length L in order to accommodate varying sizes of bucket B. It is anticipated that the telescoping arms 220 can be adjusted to conform to circular, oval, rectangular, and round openings of buckets, as well as any other configuration of bucket opening.

Similar to the preceding embodiment, integral with and extending upward from at least two of the arms 220 are vertical support columns 232 which may be channel shaped as illustrated in FIG. 2. The top of each vertical support column 232 is formed into a support-type cradle 236, and configured to allow, for example, a horizontal member 238 (i.e. handle) of an associated rotational drive 212, to rest or lay in a recess 252 in the cradle 236. The mud mixer 200 includes a drive shaft 240 extending downwardly from the barrel 216 and also includes a detachable mixing paddle 242 configured for mixing viscous fluids. A drive end 244 of the barrel 216 has an opening 250 into which the rotational drive 212, such as a drill, may be inserted. When the rotational drive 212 is inserted, it is connected to the detachable mixing paddle 242 through the drive shaft 240. It is contemplated that many different types of rotational drives 212 may be positioned in the opening of the barrel 216 of the mud mixer 200 and that the rotational drive 212 may be motorized or manual. One or more bearings 260 may be included to facilitate smooth rotation of the shaft 240.

In each of the embodiments discussed, the mud mixer 100, 200, and thus, the rotational drive 112, 212, is attached directly onto the bucket B. When in use, the arms 120, 220 attached to the bucket B counteract the rotational forces on the bucket B of the paddle 142, 242 through the viscous fluid (for example, drywall compound). By attaching the rotational drive 112, 212 directly to the bucket B via the frame 114, 214, the bucket B does not rotate or vibrate in reaction to the rotational force of the paddle 142, 242 through the viscous fluid.

In addition, the mud mixer 100, 200 is configured to stand alone while in use; the mixer 100, 200 requires no user intervention while in use in order to remain upright or centered. The drive shaft 140, 240 is positioned along a center axis A of the mud mixer 100, 200 such that the mixing paddle 142, 242 is centered with respect to the bucket circumference in the bucket B when the frame 114, 214 is affixed to the bucket B. Thus, the paddle 142, 242 does not score the sides of the bucket B or otherwise cause damage to the bucket B. In addition, because the drive shaft 140, 240 is configured to float freely in a linear direction with respect to the barrel 116, 216 when coupled to the barrel 116, 216, the present invention can be used with a variety of different buckets B having different depths.

Moreover, the floating connection prevents inadvertently pulling the rotating paddle 142, 242 from the bucket B when the mixer is operating. Rather, the paddle 142, 242 will separate from the drive 112, 212, if the drive 112, 212 is pulled from the frame 114, 214 with the drive 112, 212 operating.

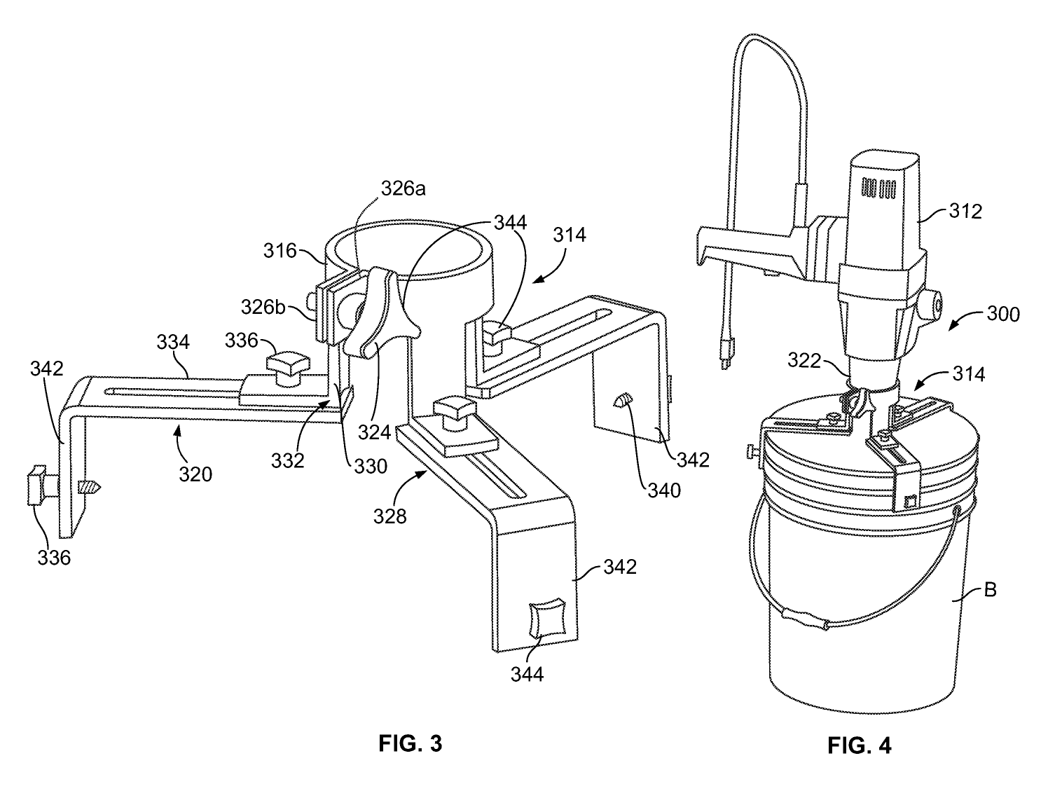

Referring now to FIGS. 3 and 4, there is shown still another embodiment of the mud mixer 300. The mixer 300 includes a clamping frame 314 and a rotational drive 312, such as the illustrated rotary drill. In this embodiment, the frame 314 includes three arms 320 that extend from a central barrel clamp 316. The clamp 316 is configured to secure the drill 312 at a collar 322 (stationary portion of the drill 312) above the chuck. A mechanical fastener 324 on a flange 326a of the barrel clamp 316 threads into an opposite flange 326b to tighten onto the collar 322 to secure the drill 312 in the clamping frame 314.

The frame arms 320 can be configured as telescoping elements 328, to allow for adjustment of the frame 314 to different diameter buckets B. The telescoping elements 328 include fixed arms 330 formed in an L-shape, as indicated at 332, that depend from the barrel clamp 316, and adjustable legs members 334 that secure to the arms 332 by fasteners 336, such as the illustrated threaded fasteners.

The frame 316 is mounted to the bucket B. In the illustrated embodiment, the frame 314 is mounted to the bucket B by threaded fasteners 338 that thread into openings 340 on depending ends 342 of the leg members 334 and tighten against the sides of the bucket B. All of the threaded members 324, 336, 338 are shown with knobs 344 so that a user can hand tighten the various mechanical fasteners. Although not shown, the drive portion of this embodiment of the mixer 300, e.g., drive shafts, barrel and floating connection, can be similar to those of the previously described embodiments 100, 200.

The advantages of the present mud mixer will be appreciated by those of skill in the art. The mud mixer is easy to use and affixes to the opening of a variety of buckets in order to mix very viscous fluids and compounds. The arms affixed to the rim of the bucket counteracts the rotational forces produced by the movement of the mixing paddle through the viscous fluid and prevents turning or vibration of the bucket while keeping the drive shaft and rotational drive centered along a centerline of the bucket.

All patents referred to herein, are incorporated herein by reference, whether or not specifically done so within the text of this disclosure. In the present disclosure, the words “a” or “an” are to be taken to include both the singular and the plural. Conversely, any reference to plural items shall, where appropriate, include the singular.

From the foregoing it will be observed that numerous modifications and variations can be effectuated without departing from the true spirit and scope of the novel concepts of the present invention. It is to be understood that no limitation with respect to the specific embodiments illustrated is intended or should be inferred. The disclosure is intended to cover by the appended claims all such modifications as fall within the scope of the claims.

What is claimed is:

1. A detachable bucket mixer for mixing viscous compounds in an associated bucket comprising:
a rotational drive; and
a clamping frame for mounting the rotational drive to the bucket, the clamping frame including a barrel having a central axis, a drive shaft, and two or more rigid arms extending radially from the barrel, a distal end of each of the two or more arms having a flange with a grip configured to affix to the bucket, and vertical support columns integral with and extending upward from at least two of the arms having a support-type cradle formed therein to accommodate the rotational drive, wherein the clamping frame is configured to prevent rotation of the bucket relative to the rotational drive.

2. The bucket mixer in accordance with claim 1 wherein the arms are telescoping.

3. The bucket mixer in accordance with claim 1 wherein the drive shaft extends downward from the barrel.

4. The bucket mixer in accordance with claim 3 wherein the drive shaft includes a detachable mixing paddle configured for mixing viscous compounds.

5. The bucket mixer in accordance with claim 4 wherein a drive end of the barrel has an opening into which the rotational drive is inserted, opposite the drive shaft.

6. The bucket mixer in accordance with claim 4 wherein when the rotational drive is inserted into the barrel, the rotational drive is connected to the detachable mixing paddle through the drive shaft.

7. The bucket mixer in accordance with claim 1 wherein there are four arms which are disposed at 90 degrees from one another.

8. The bucket mixer in accordance with claim 1 wherein the support cradle has recesses to accommodate the rotational drive.

9. The bucket mixer in accordance with claim 1 wherein the drive shaft is complementary to a receiving end of the barrel and is configured to float in a linear direction when coupled to the barrel.

10. The bucket mixer in accordance with claim 1 including one or more bearings to facilitate smooth rotational movement.

11. A detachable bucket mixer for accommodating a rotational drive to mix viscous compounds in an associated bucket comprising:
a clamping frame for mounting the rotational drive to the bucket, the clamping frame including a barrel having a central axis, a drive shaft, and two or more rigid arms extending radially from the barrel, a distal end of each of the two or more arms having a flange with a grip configured to affix to the bucket, and vertical support columns integral with and extending upward from at least two of the arms having a support-type cradle formed therein to accommodate the rotational drive, wherein the clamping frame is configured to prevent rotation of the bucket relative to the rotational drive.

12. The bucket mixer in accordance with claim 11 wherein the arms are telescoping.

13. The bucket mixer in accordance with claim 11 wherein the drive shaft extends downward from the barrel.

14. The bucket mixer in accordance with claim 11 wherein the drive shaft includes a detachable mixing paddle configured for mixing viscous compounds.

15. The bucket mixer in accordance with claim 11 wherein a drive end of the barrel has an opening into which the rotational drive is inserted, opposite the drive shaft.

16. The bucket mixer in accordance with claim 15 wherein when the rotational drive is inserted into the barrel, the rotational drive is connected to the detachable mixing paddle through the drive shaft.

17. The bucket mixer in accordance with claim 10 wherein there are four arms which are disposed at 90 degrees from one another.

18. The bucket mixer in accordance with claim 10 wherein the support cradle has recesses to accommodate the rotational drive.

19. The bucket mixer in accordance with claim 10 wherein the drive shaft is complementary to the barrel and is configured to float in a linear direction within the barrel.

20. The bucket mixer in accordance with claim 1 including one or more bearings to facilitate smooth rotational movement.

21. A detachable bucket mixer for accommodating an associated rotational drive to mix viscous compounds in an associated bucket comprising:
a clamping frame for mounting the rotational drive to the bucket, the clamping frame including a drive mount having a central axis and at least three arms extending radially from the drive mount, an end of each arm having a securing member to affix the clamping frame to the bucket, wherein the drive mount is configured to secure the associated rotational drive and wherein the clamping frame is configured to prevent rotation of the bucket relative to the rotational drive.

22. The bucket mixer in accordance with claim 21 wherein the drive mount is configured as a collar and includes a clamp for securing the rotational drive in the collar.

23. The bucket mixer in accordance with claim 22 wherein the arms are adjustable to secure the mixer to buckets of different diameters.

24. The bucket mixer in accordance with claim 22 wherein the arms include mechanical fasteners to secure the arms to the bucket.

25. The bucket mixer in accordance with claim 22 including three arms.
